(19) United States
(12) Patent Application Publication
(10) Pub. No.: US 2025/0190074 A1
(43) Pub. Date: Jun. 12, 2025

(54) ANTENNA TOUCH MULTIPLEXING DEVICES, HEADPHONES, AND ELECTRONIC DEVICES

(71) Applicant: SHENZHEN SHOKZ CO., LTD., Shenzhen (CN)

(72) Inventors: Jianhua XIE, Shenzhen (CN); Fen YOU, Shenzhen (CN); Xin QI, Shenzhen (CN)

(73) Assignee: SHENZHEN SHOKZ CO., LTD., Shenzhen (CN)

(21) Appl. No.: 19/061,977

(22) Filed: Feb. 24, 2025

Related U.S. Application Data
(63) Continuation-in-part of application No. PCT/CN2022/140324, filed on Dec. 20, 2022.

(51) Int. Cl. G06F 3/041; G06F 3/044; H01Q 1/22; H01Q 9/04; H04R 1/10

(52) U.S. Cl. CPC G06F 3/04182; G06F 3/044; H01Q 1/22; H01Q 1/2283; H01Q 9/0421; H04R 1/1041

(57) ABSTRACT

The present disclosure discloses an antenna touch multiplexing device, a headphone, and an electronic device. The antenna touch multiplexing device includes an antenna, a touch signal transmission path, a radiofrequency (RF) signal transmission path, a touch chip, and an RF chip. The touch signal transmission path connects the antenna to the touch chip. The RF signal transmission path connects the antenna to the RF chip. The touch signal transmission path includes a first low pass filtering module and a second low pass filtering module connected in series between the antenna and the touch chip. A wiring distance between the first low pass filtering module and the antenna is less than a wiring distance between the first low pass filtering module and the second low pass filtering module. A wiring distance between the second low pass filtering module and the touch chip is less than a wiring distance between the first low pass filtering module and the second low pass filtering module. Through the above manner, the present disclosure reduces the influence of the coupling between the touch signal transmission path and the RF signal on the touch control performance and optimize the touch control performance.

### CROSS REFERENCE TO RELATED APPLICATIONS

This application is a continuation-in-part of International Patent Application No. PCT/CN2022/140324, field on Dec. 20, 2022, the entire contents of which are incorporated herein by reference.

### TECHNICAL FIELD

The present disclosure relates to the field of electronic devices, and in particular, to antenna touch multiplexing devices, headphones, and electronic devices.

### BACKGROUND

In some wireless communication devices such as wireless headphones, it is often necessary to have both radiofrequency (RF) communication functions and touch control functions. In related technology, an antenna is applied to transmit and receive RF signals, and the antenna can also have the function of a touch electrode to realize antenna touch multiplexing. In a current antenna touch multiplexing device, when transmitting an RF signal, the RF signal is coupled to the touch signal transmission path, resulting in deterioration of touch performance. In addition, the RF signal may experience losses in a touch chip and related circuits, resulting in deterioration of antenna performance.

### SUMMARY

Embodiments of the present disclosure provide an antenna touch multiplexing device, a headphone, and an electronic device that can reduce the impact of coupling between a touch signal transmission path and a radiofrequency (RF) signal on touch performance and optimize touch performance.

One of the embodiments of the present disclosure provide an antenna touch multiplexing device. The antenna touch multiplexing device includes an antenna, a touch signal transmission path, an RF signal transmission path, a touch chip, and an RF chip. The touch signal transmission path may be connected to the antenna and configured to transmit a touch signal. The RF signal transmission path may be connected to the antenna and configured to transmit an RF signal. The touch chip may be connected to the antenna via the touch signal transmission path. The RF chip may be connected to the antenna via the RF signal transmission path. The touch signal transmission path may include a first low pass filtering module and a second low pass filtering module connected in series between the antenna and the touch chip. A wiring distance between the first low pass filtering module and the antenna may be less than a wiring distance between the first low pass filtering module and the second low pass filtering module. A wiring distance between the second low pass filtering module and the touch chip may be less than a wiring distance between the first low pass filtering module and the second low pass filtering module.

One of the embodiments of the present disclosure provide a headphone. The headphone may include an antenna touch multiplexing device, a housing, and a support assembly as described above. The antenna touch multiplexing device may be provided within the housing and close to the housing. The support assembly may be configured to support the housing and the antenna touch multiplexing device to be worn on a wearing position.

One of the embodiments of the present disclosure provides an electronic device. The electronic device may include the antenna touch multiplexing device described above.

The beneficial effect of the present disclosure is that, distinguishing from the prior art situation, the touch chip is connected to the antenna through the touch signal transmission path. The RF chip is connected to the antenna through the RF transmission path. The antenna may transmit the RF signal, and may play the role of a touch electrode. In this way, the function of the antenna and the touch control function are integrated into one, which makes the antenna touch multiplexing device compact, and thus reduces layout space conflict in electronic devices such as the headphone and other electronic devices of the present disclosure. In the embodiment of the antenna touch multiplexing device of the present disclosure, the touch signal transmission path includes a first low pass filtering module and a second low pass filtering module connected in series. The wiring distance between the first low pass filtering module and the antenna is less than the wiring distance between the first low pass filtering module and the second low pass filtering module. The wiring distance between the second low pass filtering module and the touch chip is less than the wiring distance between the first low pass filtering module and the second low pass filtering module. In other words, the first low pass filtering module is disposed proximate to the antenna, and the second low pass filtering module is disposed proximate to the touch chip. In this way, the first low pass filtering module may block the RF signal in the antenna touch multiplexing device and reduce its interference with the touch chip. The second low pass filtering module may further block the RF signal, further reducing the interference of the RF signal on the touch signal. As the first low pass filtering module is set close to the antenna, the second low pass filtering module is set close to the touch chip. The RF signal radiated from the antenna is less likely to be coupled with the wire between the first low pass filtering module and the antenna and the wire between the second low pass filtering module and the touch chip, ensuring the reliability of the touch control performance. Moreover, signals generated by the coupling of the wire between the first low pass filtering module and the second low pass filtering module with the RF signals are blocked by the first low pass filtering module and the second low pass filtering module from two ends of the wire, respectively. The coupling of the wire between the first low pass filtering module and the second low pass filtering module with the RF signal may not affect the touch chip and the RF chip. Thus, the relative position of the antenna and the touch chip may be flexibly arranged to optimize the spatial layout of the antenna touch multiplexing device.

### BRIEF DESCRIPTION OF THE DRAWINGS

The accompanying drawings herein, which are incorporated into and form a part of the present disclosure, illustrate embodiments consistent with the present disclosure and are used in conjunction with the present disclosure to explain the principles of the present disclosure. Furthermore, these accompanying drawings and textual descriptions are not intended to limit the scope of the present disclosure in any way, but rather to illustrate the concepts of the present disclosure for those skilled in the art by reference to particular embodiments, and wherein:

FIG. 1 is a schematic diagram illustrating an electronic device according to some embodiments of the present disclosure;

FIG. 2 is a schematic diagram illustrating a headphone according to some embodiments of the present disclosure;

FIG. 3 is a schematic diagram illustrating the headphone shown in FIG. 2 when it is worn;

FIG. 4 is a schematic diagram illustrating an antenna touch multiplexing device according to some embodiments of the present disclosure;

FIG. 5 is a schematic diagram illustrating the antenna touch multiplexing device shown in FIG. 4;

FIG. 6 is a schematic diagram illustrating an antenna touch multiplexing device according to some embodiments of the present disclosure;

FIG. 7 is a schematic diagram illustrating the antenna touch multiplexing device shown in FIG. 6;

FIG. 8 is a schematic diagram illustrating an antenna touch multiplexing device according to some embodiments of the present disclosure;

FIG. 9 is a schematic diagram illustrating an antenna touch multiplexing device according to some embodiments of the present disclosure;

FIG. 10 is a schematic diagram illustrating an antenna layout according to some embodiments of the present disclosure; and

FIG. 11 is a schematic diagram illustrating an antenna layout according to some embodiments of the present disclosure.

### DETAILED DESCRIPTION

To more clearly illustrate the technical solutions and advantages of the present disclosure, the technical solutions in the embodiments of the present disclosure will be clearly and completely described below in connection with the embodiments of the present disclosure. Obviously, the described embodiments are a part of the embodiments of the present disclosure, and not all of the embodiments. Based on the embodiments in the present disclosure, all other embodiments obtained by those having ordinary skills in the art without making creative efforts fall within the scope of protection of the present disclosure. The following embodiments and features in the embodiments may be combined with each other without conflict.

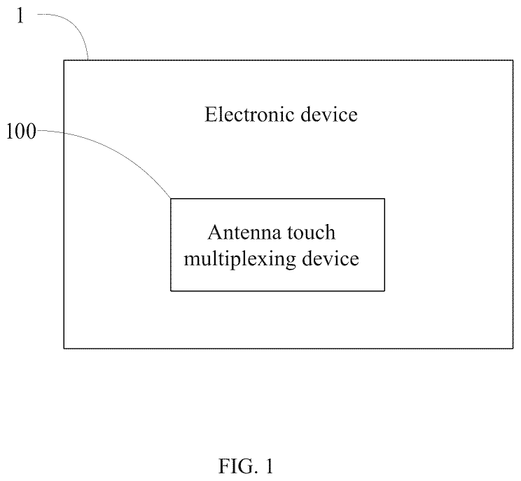

Referring to FIG. 1, embodiments of the present disclosure provide an electronic device 1. The electronic device 1 includes an antenna touch multiplexing device 100. The electronic device 1 may be a wireless headphone, a smart bracelet, a smartwatch, a smart speaker, or the like, that requires both touch function and radiofrequency function.

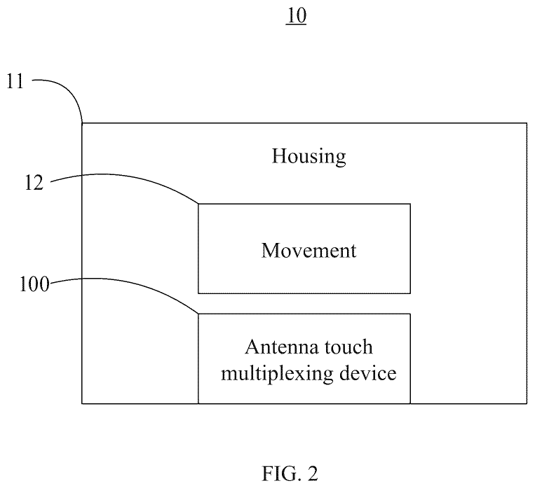

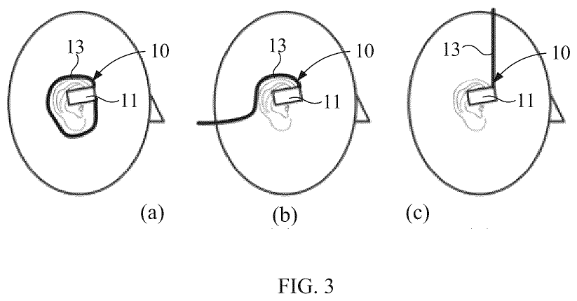

Referring to FIG. 2 and FIG. 3, embodiments of the present disclosure provide a headphone 10. The headphone 10 may include an antenna touch multiplexing device 100, a housing 11, a movement 12, and a support assembly 13. The support assembly 13 is configured to support the housing 11 and the antenna touch multiplexing device 100 to be worn at a wearing position. The aforementioned wearing position may be a specific position on the user's head, such as the mastoid process, temporal bone, parietal bone, frontal bone, etc., of the head, the front side of the ear back away from the head, or a position on the left or right side of the head that is located in front of the user's ear on the sagittal axis of the human body. Components such as the movement 12 may be provided inside the housing 11, and the movement 12 may convert an electrical signal into a mechanical vibration. The mechanical vibration may be transmitted primarily through a medium such as the user's skull (i.e., bone conduction) to create a bone conduction sound, or primarily through a medium such as air (i.e., air conduction) to create an air conduction sound. The support assembly 13 may be provided in a ring shape and disposed around the user's ear, as shown in (a) in FIG. 3. The support assembly 13 may also be provided as an ear hook and a rear-hanging structure cooperating to be disposed around the back side of the head, as shown in (b) in FIG. 3. Alternatively, the support assembly 13 may be provided as a headband structure and disposed around the top of the user's head, as shown in (c) in FIG. 3. The antenna touch multiplexing device 100 may enable the headphone 10 to have the capability of radiofrequency communication, thereby enabling the headphone 10 to communicate with a smart terminal device such as a cell phone or a tablet. The antenna touch multiplexing device 100 may also enable the headphone 10 to have a touch function, thereby enabling a user to control the headphone 10 through the touch function. Alternatively, signals generated by the user's touching of the headphone 10 may be transmitted to the aforementioned smart terminal device via the antenna touch multiplexing device 100. The antenna touch multiplexing device 100 is disposed within and close to the housing 11. The antenna touch multiplexing device 100 integrates the function of the antenna 110 and the touch function and is provided on the housing 11 of the headphone 10. The multiplexing of the antenna 110 with touch-sensitive electrodes may enable the headphone 10 to be compact and reduce spatial conflicts in the layout of electronic components.

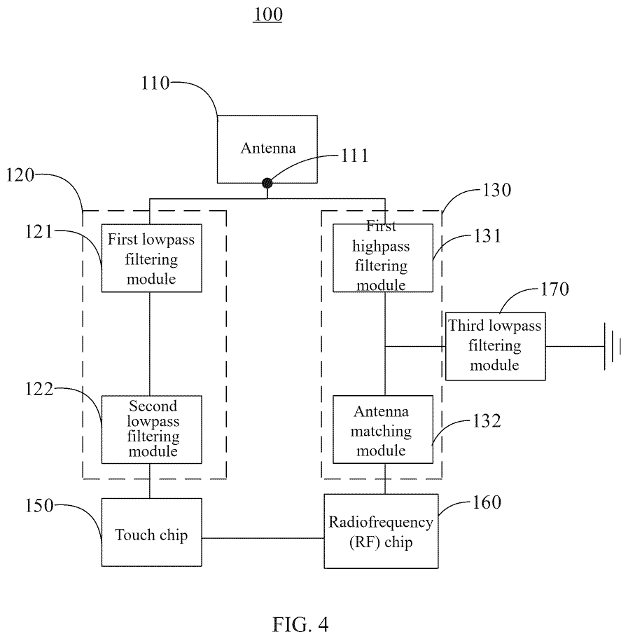

Referring to FIG. 4, embodiments of the present disclosure provide an antenna touch multiplexing device 100. The antenna touch multiplexing device 100 includes an antenna 110, a touch signal transmission path 120, a radiofrequency (RF) signal transmission path 130, a touch chip 150, and an RF chip 160. The antenna 110 is connected to the touch chip 150 via the touch signal transmission path 120, and a touch signal received by the antenna 110 may be transmitted to the touch chip 150 via the touch signal transmission path 120. The antenna 110 is connected to the RF chip 160 via the RF signal transmission path 130, and an RF signal transmitted and received by the antenna 110 may be transmitted to the RF chip 160 via the RF signal transmission path 130. The touch chip 150 is communicatively connected with the RF chip 160. The touch chip 150 may transmit specific state information of a touch trigger to the RF chip 160. A signal received by the RF chip 160 for controlling one or more parameters of the touch chip 150 may be transferred to the touch chip 150.

The antenna 110 may be a two-dimensional antenna, and the two-dimensional antenna is composed of a sheet metal having a certain area, which may be at least referred to the related technology, and will not be repeated herein. The antenna 110 may be configured to conduct the RF signal. The antenna 110 may radiate one or more guided waves in the antenna touch multiplexing device 100 into space and transform the guided waves into free space electromagnetic waves. The antenna 110 may also receive one or more free space electromagnetic waves in space to be transformed into guided waves flowing in the antenna touch multiplexing device 100. The antenna 110 enables the antenna touch multiplexing device 100 to communicate with the outside world based on the conduction of the RF signal. The antenna 110 may form a coupling capacitance on the surface when the antenna 110 is in contact with a user's finger or other device with an electric field. The change in the capacitance value of the coupling capacitance may generate a touch signal. In summary, the antenna 110 has both the ability to transform the RF signal and the ability to sense touches, and the antenna 110 also serves as a touch-sensing electrode. In this way, the function of the antenna 110 and the touch control function may be integrated into one single device, to make the antenna touch multiplexing device 100 compact and to reduce spatial conflicts in the layout of electronic components. In one embodiment, the antenna 110 has an antenna feed point 111, and the touch signal transmission path 120 and the RF signal transmission path 130 are both electrically connected with the antenna feed point 111 to exchange signals with the antenna 110 through the antenna feed point 111.

The touch signal transmission path 120 is connected with the antenna 110 and is configured to transmit the touch signal. The touch signal transmission path 120 includes a first low pass filtering module 121 and a second low pass filtering module 122 connected in series between the antenna 110 and the touch chip 150. A low-frequency signal may pass through the first low pass filtering module 121 and the second low pass filtering module 122 normally, while a high-frequency signal exceeding a set threshold is blocked and attenuated. The first low pass filtering module 121 and the second low pass filtering module 122 may prevent the RF signal in the RF signal transmission path 130 from transmitting to the touch chip 150, so as to minimize the impact of the RF signal on the touch performance.

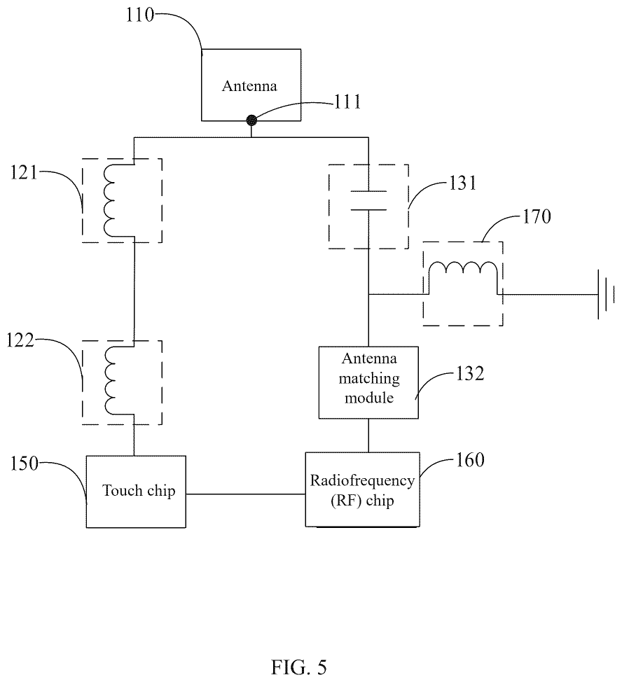

Specifically, referring to FIG. 5, the first low pass filtering module 121 is an inductive circuit. The first low pass filtering module 121 may be a circuit including an inductor or a magnetic bead, or a circuit including an inductor and a capacitor, etc., and the final circuit is rendered inductive. The inductive circuit allows the low-frequency signal to pass through normally and prevents the high-frequency signal from passing through. Optionally, the inductance value of the first low pass filtering module 121 is greater than or equal to 22 nH. For example, an inductive element or a magnetic bead element having an inductance value of 22 nH is selected as the first low pass filtering module 121. The natural frequency of the inductive circuit with the inductance value of 22 nH forms a stopband around 2.4 GHz or 1.4 GHz, equivalent to an open circuit. Concurrently, while the inductive circuit with the inductance value of 22 nH is open at high frequencies, and acts as a short circuit to a touch signal below 500 kHz, thus achieving low pass high-impedance filtering. The touch signal in the touch multiplexing circuit of the antenna 110 has a suitable frequency range of below 500 kHz and the RF signal in the touch multiplexing circuit of the antenna 100 has a suitable frequency range of above 2.4 GHz. The first low pass filtering module 121 with the inductance value that is greater than or equal to 22 nH may well meet the needs of the antenna touch multiplexing device 100.

The second low pass filtering module 122 is an inductive circuit. The second low pass filtering module 122 may be a circuit composed of an inductor or a magnetic bead, or a circuit including an inductor and a capacitor, etc., and the final circuit is rendered inductive. The inductive circuit allows the low-frequency signal to pass through normally and prevents the high-frequency signal from passing through. Optionally, the inductance value of the second low pass filtering module 122 is greater than or equal to 22 nH. For example, an inductive element or a magnetic bead element having an inductance value of 22 nH is selected as the second low pass filtering module 122. The natural frequency of the inductive circuit with the inductance value of 22 nH forms a stopband around 2.4 GHz or 1.4 GHz, equivalent to an open circuit. Concurrently, while the inductive circuit with the inductance value of 22 nH is open at high frequencies, and acts as a short circuit to a touch signal below 500 kHz, thus achieving low pass high-impedance filtering. The touch signal in the touch multiplexing circuit of the antenna 110 has a suitable frequency range of below 500 kHz and the RF signal in the touch multiplexing circuit of the antenna 100 has a suitable frequency range of above 2.4 GHz. The second low pass filtering module 122 with the inductance value that is greater than or equal to 22 nH may well meet the needs of the antenna touch multiplexing device 100 to cut off the RF signal to pass the touch signal.

Because the RF signal may be coupled with the touch signal transmission path 120, an interfering signal may be generated and the touch performance may be deteriorated. In order to improve this technical problem, the antenna touch multiplexing device 100 of the present disclosure has a wiring distance between the first low pass filtering module 121 and the antenna 110 to be smaller than a wiring distance between the first low pass filtering module 121 and the second low pass filtering module 122. A wiring distance between the second low pass filtering module 122 and the touch chip 150 is less than the wiring distance between the first low pass filtering module 121 and the second low pass filtering module 122. In other words, the first low pass filtering module 121 is provided close to the antenna 110, and the second low pass filtering module 122 is provided close to the touch chip 150. In this way, the first low pass filtering module 121 may block the RF signal (guided waves) in the antenna touch multiplexing device 100, reducing its interference on the touch chip 150. The second low pass filtering module 122 may further block the RF signal (guided waves), further reducing the interference of the RF signal on the touch signal. As the first low pass filtering module 121 is set close to the antenna 110 and the second low pass filtering module 122 is set close to the touch chip 150, the RF signal (free-space electromagnetic waves) radiated by the antenna 110 is less likely to couple with the wire between the first low pass filtering module 121 and the antenna 110 and the wire between the second low pass filtering module 122 and the touch chip 150, which ensures reliable touch control performance. Further, the signal generated by the coupling of the wire between the first low pass filtering module 121 and the second low pass filtering module 122 and the RF signal radiated from the antenna 110 (free space electromagnetic waves) may be blocked by the first low pass filtering module 121 and the second low pass filtering module 122 at the two ends of the wire, and the coupling of the wire between the first low pass filtering module 121 and the second low pass filtering module 122 and the RF signal may not affect the touch chip 150 and the RF chip 160, so that relative position of the antenna 110 and the touch chip 150 may be flexibly arranged, to optimize the spatial layout of the antenna touch multiplexing device 100.

Optionally, the wiring distance between the first low pass filtering module 121 and the antenna 110 is within a range of 0.2-90 mm. For example, the wiring distance between the first low pass filtering module 121 and the antenna 110 is within a range of 0.3-70 mm, or a range of 3-50 mm, or a range of 5-30 mm, or a range of 0.2-0.3 mm. If the wiring distance between the first low pass filtering module 121 and the antenna 110 is too long, it may increase the possibility of the RF signal coupling with the wire, which deteriorates the touch control performance. If the wiring distance between the first low pass filtering module 121 and the antenna 110 is too short, it may result in an overly high distribution density of components, which reduces the flexibility of the layout.

Optionally, the wiring distance between the second low pass filtering module 122 and the touch chip 150 is within a range of 0.2-90 mm. For example, the wiring distance between the second low pass filtering module 122 and the touch chip 150 is within a range of 0.3-70 mm, or a range of 3-50 mm, or a range of 5-30 mm, or a range of 0.2-0.3 mm. If the wiring distance between the second low pass filtering module 122 and the touch chip 150 is too long, it may increase the possibility of the RF signal coupling with the wire, which deteriorates the touch performance. If the wiring distance between the second low pass filtering module 122 and the touch chip 150 is too short, it may result in an overly high distribution density of the components, which reduces the flexibility of the layout.

Referring to FIG. 4, the RF signal transmission path 130 is coupled to the antenna 110 and is configured to transmit the RF signal. The RF signal transmission path 130 includes a first high pass filtering module 131 connected in series between the antenna 110 and the RF chip 160. The first high pass filtering module 131 allows a signal above a certain frequency to pass through, while blocking signals of a lower frequency from passing through. The first high pass filtering module 131 prevents the touch signal of the antenna 110 from passing through, thereby reducing the impact of the touch signal on the RF performance and improving the reliability of the touch performance.

Referring to FIG. 5, specifically, the first high pass filtering module 131 is a capacitive circuit. The first high pass filtering module 131 may be a circuit including one or more capacitors and other electronic components, and the circuit is ultimately capacitive. The capacitive circuit allows a high-frequency signal to pass through and prevents a low-frequency signal from passing through. Optimally, the capacitance value of the first high pass filtering module 131 is less than or equal to 1 μF. For example, a capacitor with a capacitance value of 1 μF is selected as the first high pass filtering module 131. The capacitor with a capacitance value of 1 μF is equivalent to an open circuit for a signal below 500 kHz and a short circuit for a signal around 2.4 GHz, thus realizing high pass and low-resistance filtering. A suitable frequency range for the touch multiplexing circuit of the antenna 110 is below 500 kHz, and a suitable frequency range of the RF signal is above 2.4 GHz. The first high pass filtering module 131 of less than or equal to 1 μF may satisfy the need for the RF signal transmission path 130 in the antenna touch multiplexing device 100 to cut off the touch signal and pass through the RF signal.

The antenna 110 naturally has a certain amount of parasitic capacitance when used as a touch electrode. The presence of parasitic capacitance weakens the sensing ability of the touch chip 150. While a compensation circuit may be designed within the touch chip 150 to compensate for the effect of the parasitic capacitance, the components in the RF signal transmission path 130 and the RF chip 160 may increase the parasitic capacitance and may exceed the touch chip 150's ability to compensate. In order to ameliorate this technical problem, referring to FIG. 4 and FIG. 5, the antenna touch multiplexing device 100 in the embodiment of the present disclosure also includes a third low pass filtering module 170. An end of the third low pass filtering module 170 is connected to a node between the first high pass filtering module 131 and the RF chip 160, and the other end of the third low pass filtering module 170 is grounded. For example, as shown in FIG. 5, the first high pass filtering module 131 includes a capacitor, the third low pass filtering module 170 includes an inductor, and the inductor is provided on a side of the capacitor away from the antenna 110 and grounded.

The third low pass filtering module 170 is an inductive circuit. The third low pass filtering module 170 may be a circuit including an inductor or a magnetic bead, or a circuit including an inductor with a capacitor, etc., and the final circuit is rendered inductive. The inductive circuit allows the low-frequency signal to pass through normally and prevents the high-frequency signal from passing through. Similar to the first low pass filtering module 121 and the second low pass filtering module 122, the inductance value of the third low pass filtering module 170 is greater than or equal to 22 nH. In this way, when the antenna touch multiplexing device 100 conducts the low-frequency signal, the RF chip 160 may experience a ground short circuit relative to the touch signal transmission path 120 so that the parasitic capacitance of the components such as the RF chip 160 do not affect the touch chip 150, which optimizes touch performance. Therefore, the design of the RF chip 160 may also be unconstrained by the touch performance and may facilitate the design of the RF signal transmission path 130 and the RF chip 160. The arrangement of the third low pass filtering module 170 has less impact on the RF signal transmission due to the low pass and high-resistance characteristics of the third low pass filtering module 170 during RF signal transmission. In addition, due to the load effect generated by the RF chip 160 when switching the signal transmission and signal reception, the size of the parasitic capacitance is changed, which affects the recognition of capacitance by the touch chip 150 and leads to touch failure or false touch. By setting the third low pass filtering module 170, for a low-frequency touch signal, the RF chip 160 is equivalent to being short circuited by the third low pass filtering module 170. Therefore, the parasitic capacitance change caused by the load change of the RF chip 160 may not be transmitted to the touch chip 150, thus avoiding the touch chip 150 from affecting touch performance due to the recognition of the parasitic capacitance change.

In one embodiment, the antenna 110 is an electrically small antenna due to the limitation of the usage space. As the electrically small antenna 110 has a high capacitive impedance and a small resistance, the RF signal cannot be matched with the electrically small antenna 110, which may cause a decrease in the reliability of the RF signal transmission. In order to improve the technical problem, the antenna touch multiplexing device 100 further includes an antenna matching module 132. The antenna matching module 132 is disposed between the first high pass filtering module 131 and the RF chip 160, an end of the antenna matching module 132 is connected to the first high pass filtering module 131 and another end of the antenna matching module is connected to the RF chip 160. The antenna matching module 132 may tune the RF signal to the electrically small antenna 110. The antenna matching module 132 may use an L-type matching circuit, a T-type matching circuit, or a PI-type matching circuit, which are not specifically limited herein.

Further, one end of the third low pass filtering module 170 is connected to a node between the first high pass filtering module 131 and the antenna matching module 132. In this way, when the antenna touch multiplexing device 100 conducts the low-frequency signal, the RF chip 160 and the antenna matching module 132 experience a ground short circuit relative to the touch signal transmission circuit, so that the RF chip 160 and the parasitic capacitance of the antenna matching module 132 do not affect the touch chip 150 to optimize the touch control performance. In this way, the design of the RF chip 160 and the antenna 110 matching circuit may also be unrestricted by the touch control performance, which facilitates the design of the antenna matching module 132 and the RF chip 160 in the RF signal transmission path 130. The arrangement of the third low pass filtering module 170 has less impact on the RF signal transmission due to the low pass and high-resistance characteristics of the third low pass filtering module 170 during RF signal transmission.

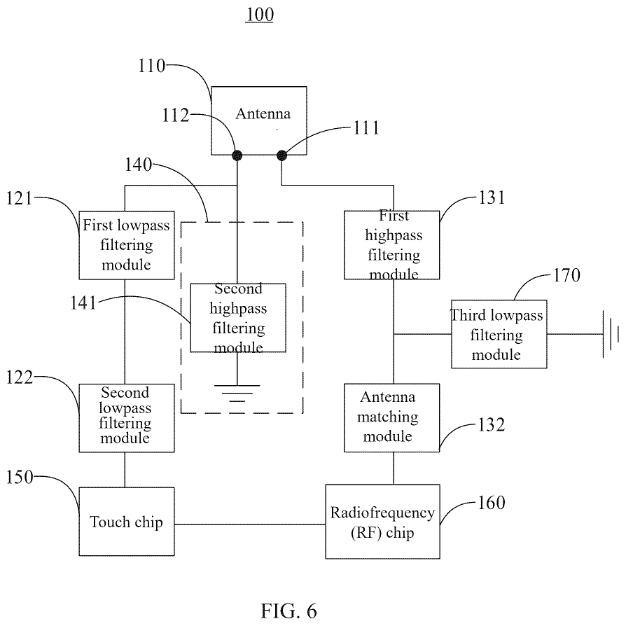

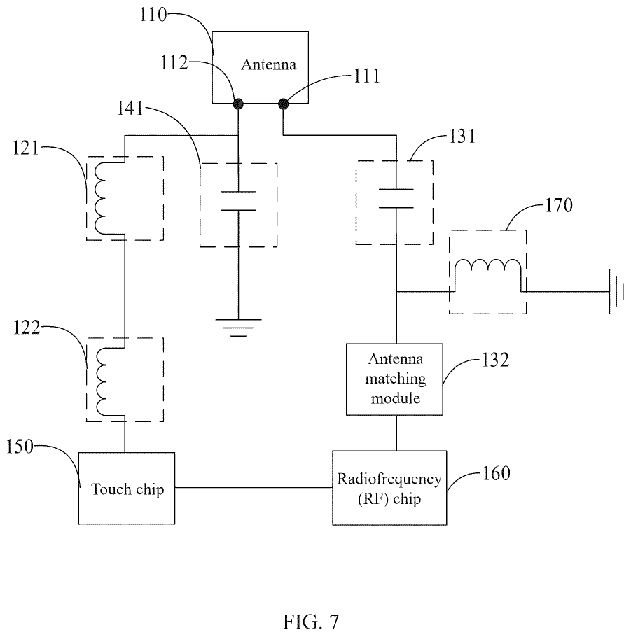

In one embodiment, referring to FIG. 6 and FIG. 7, the antenna 110 has an antenna feed point 111 and an antenna location 112, and the RF signal transmission path 130 is electrically connected to the antenna feed point 111. The touch signal transmission path 120 is electrically connected to the antenna location 112. The antenna feed point 111 and the antenna location 112 are spaced apart by a certain distance, so that the distance between the RF signal transmission path 130 and the touch signal transmission path 120, and the distance between the RF chip 160 and the touch chip 150 may all be set larger, thereby reducing the requirement for circuit board integration and lowering the design cost. The antenna 110 in the embodiments of the present disclosure may be any antenna with antenna feed points and antenna locations, not limited to antennas with only antenna feed points, making the design and selection of the antenna 110 more flexible.

Further, the antenna touch multiplexing device 100 further includes a grounding path 140. The grounding path 140 includes a second high pass filtering module 141. One end of the second high pass filtering module 141 is electrically connected to the antenna location 112. The other end of the second high pass filtering module 141 is grounded. When transmitting the RF signal, the grounding path 140 is equivalent to a distributed parameter inductor, which may have the effect of tuning the distributed parameter capacitance of the electrically small antenna 110. Therefore, the influence of the distributed parameter capacitance on the electromagnetic waves emitted by the antenna 110 is reduced or eliminated and the operating frequency bandwidth of the antenna 110 is broadened.

Specifically, the second high pass filtering module 141 further forms an inductor-capacitor (LC)resonant circuit within the grounding path 140. For example, the second high pass filtering module 141 includes a capacitor and an inductor. Alternatively, the second high pass filtering module 141 is provided to form an LC resonant circuit in conjunction with a wire within the grounding path 140.

Specifically, the wire within the grounding path 140 may be equivalent to a distributed parameter inductor, and then the wire is equivalent to the capacitive second high pass filtering module 141 as an LC resonant circuit. In this manner, the second high pass filtering module 141 is set to form an LC resonant circuit in conjunction with the wire within the grounding path 140.

On the basis of the above embodiment, a resonant frequency of the LC resonant circuit is less than an operating frequency of the RF signal. The LC resonant circuit in this way is inductive. The grounding path 140 is inductive, then the antenna 110 may include an antenna with grounding such as an inverted-f antenna (IFA), a planar inverted-f antenna (PIFA), or LOOP. Compared to antenna 110 with only antenna feed point 111 under the same headroom condition, the antenna 110 with the antenna feed point 111 and the antenna location 112 as described above may tune the distributed parameter capacitance by forming a distributed parameter inductance, which has a wider operating frequency bandwidth.

The second high pass filtering module 141 is a capacitive circuit and has a capacitance value of greater than or equal to 22 pF. The second high pass filtering module 141 is a capacitive circuit and has a capacitance value of less than or equal to 1 μF. The second high pass filtering module 141 with a capacitance value in the above range is equivalent to an open circuit for signals below 500 kHz, so that the grounding path 140 does not affect the transfer of the touch signal. The second high pass filtering module 141 with a capacitance value in the above range is equivalent to a short circuit for signals below 2.4 GHz. In this way the second high pass filtering module 141 may achieve high pass and low-impedance filtering to enable the antenna touch multiplexing device 100 to operate on the RF signal when the grounding path 140 form the distributed parameter inductance to tune the distributed parameter capacitance. By setting the capacitance range of the second high pass filtering module 141 in the present disclosure, the grounding path 140 may increase the operating frequency bandwidth of the antenna 110 without affecting the transmission of the touch signal.

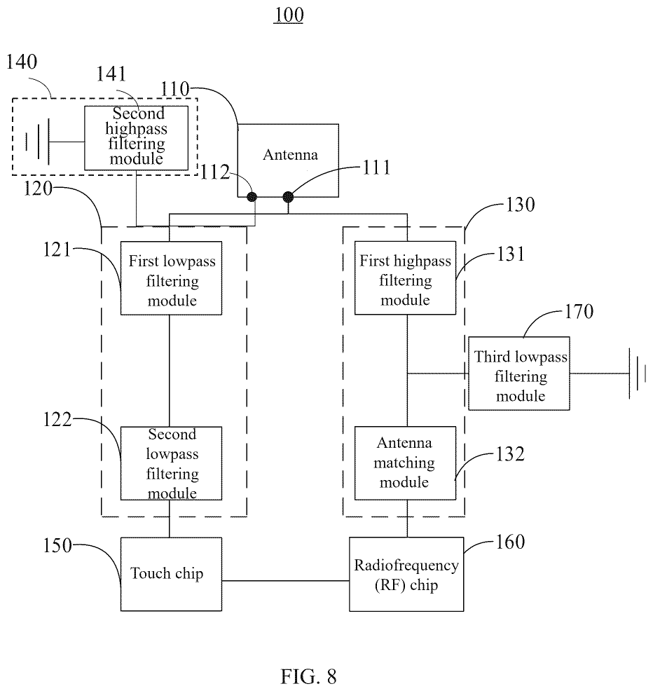

FIG. 8 is a schematic diagram illustrating an antenna touch multiplexing device according to some embodiments of the present disclosure. In some embodiments, referring to FIG. 8, the antenna 110 has the antenna feed point 111 and the antenna location 112. The RF signal transmission path 130 and the touch signal transmission path 120 are electrically connected to the antenna feed point 111, respectively, and the grounding path 140 is electrically connected to the antenna location 112. The grounding path 140 includes a second high pass filtering module 141. One end of the second high pass filtering module 141 is electrically connected to the antenna location 112, and the other end of the second high pass filtering module 141 is grounded.

When transmitting the RF signal, the grounding path 140 is equivalent to a distributed parameter inductance, which may tune the distributed parameter capacitance of the antenna 110, thereby reducing or eliminating the influence of the distributed parameter capacitance on the electromagnetic waves emitted by the antenna 110 and broadening the operating frequency bandwidth of the antenna 110.

Specifically, the second high pass filtering module 141 further forms an LC resonant circuit within the grounding path 140. For example, the second high pass filtering module 141 includes a capacitance and an inductance. Alternatively, the second high pass filtering module 141 may be configured to cooperate with the wiring within the grounding path 140 to form the LC resonant circuit. Specifically, the wiring in the grounding path 140 is equivalent to the distributed parameter inductance, then the wiring and the capacitive second high pass filtering module 141 are equivalent to the LC resonant circuit. In this way, the second high pass filtering module 141 is set to cooperate with the wiring in the grounding path 140 to form the LC resonant circuit.

On the basis of the above embodiments, the resonant frequency of the LC resonant circuit is lower than the operating frequency of the RF signal. The LC resonant circuit in this way is inductive. The grounding path 140 is inductive, then the antenna 110 may include an antenna with grounding such as an inverted-F antenna (IFA, a planar inverted-F antenna (PIFA), or LOOP). Compared to antenna 110 with only antenna feed point 111 under the same headroom condition, the antenna 110 with the antenna feed point 111 and the antenna location 112 as described above may tune the distributed parameter capacitance by forming a distributed parameter inductance, which has a wider operating frequency bandwidth.

The second high pass filtering module 141 is a capacitive circuit with a capacitance value greater than or equal to 22 pF and less than or equal to 1 μF. The second high pass filtering module 141 with the capacitance value in the above range is equivalent to an open circuit for signals below 500 kHz, so that the grounding path 140 does not affect the transfer of the touch signal. The second high pass filtering module 141 with the capacitance value in the above range is equivalent to a short circuit for signals below 2.4 GHz. In this way the second high pass filtering module 141 may achieve high pass and low impedance filtering, thereby the grounding path 140 of the antenna touch multiplexing device 100 enables to form the distributed parameter inductance to tune the distributed parameter capacitance when the RF signal is operating, broadening the operating frequency bandwidth.

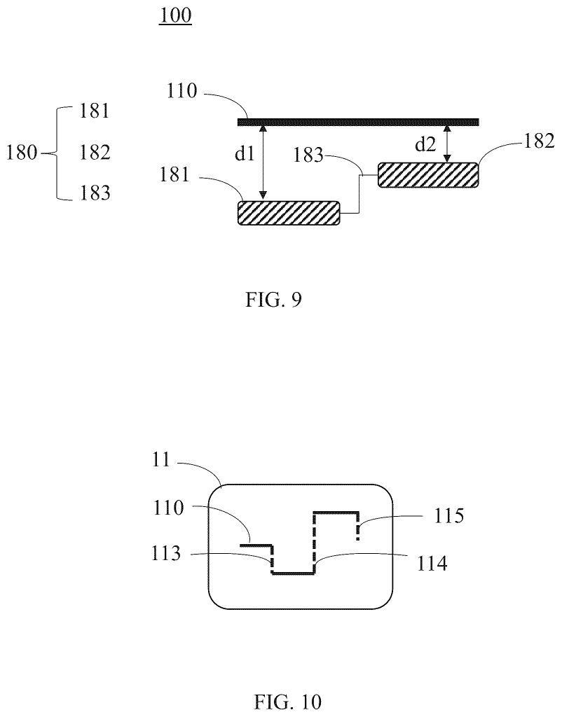

FIG. 9 is a schematic diagram illustrating an antenna touch multiplexing device according to some embodiments of the present disclosure. FIG. 9 shows a schematic side view of the antenna touch multiplexing device 100. As shown in FIG. 9, the antenna touch multiplexing device 100 may include an antenna 110 and a circuit board structure 180. When the antenna touch multiplexing device 100 is installed in the headphone 10, the antenna 110 is placed close to the housing 11 of the headphone 10, and the circuit board structure 180 is placed on the side of the antenna 110 away from the housing 11.

One or more components in the antenna touch multiplexing device 100 may be implemented on the circuit board structure 180. For example, the circuit board structure 180 may include a circuit board 181 and a circuit board 182. The circuit board 181 and the circuit board 182 may be connected through a connector 183. Merely by way of example, each of the circuit board 181 and the circuit board 182 may include a printed circuit board (PCB), and the connector 183 may include a flexible printed circuit (FPC). The RF signal transmission path 130 and the RF chip 160 may be implemented on the circuit board 181, while the touch signal transmission path 120, the touch chip 150, and/or the grounding path 140 may be implemented on the circuit board 182. In some embodiments, the antenna 110 may be connected to the circuit board 181 and the circuit board 182, respectively, through the antenna feed point 111. In some embodiments, the antenna 110 may be connected to the circuit board 182 through the antenna feed point 111, and further connected to the circuit board 181 through the wiring on the circuit board 182 and the connector 183. In some embodiments, the antenna 110 may be connected to the circuit board 182 through the antenna feed point 111 and the antenna location 112. For example, the antenna 110 may be connected to the touch signal transmission path 120 and the touch chip 150 on the circuit board 182 through the antenna feed point 111, and connected to the grounding path 140 through the antenna location 112.

In some embodiments, as shown in FIG. 9, the circuit board 181 and the circuit board 182 may be placed at intervals from the antenna 110, respectively. For example, a plane where the circuit board 181 is located and a plane where the circuit board 182 is located may be parallel to a plane where the antenna 110 is located. By placing the circuit board 181 and the circuit board 182 parallel to the antenna 110, the structure of the antenna touch multiplexing device 100 may be compact, which is beneficial for reducing the volume of the antenna touch multiplexing device 100 and the headphone 10. In some embodiments, a distance d1 between the circuit board 181 and the antenna 110 may be greater than a distance d2 between the circuit board 182 and the antenna 110. This setting may reduce the parasitic capacitance generated between the circuit board 181 and the antenna 110, thereby reducing the impact of the RF chip 160 and the RF signal transmission path 130 on the touch chip 150. In addition, this setting may reduce the overall parasitic capacitance formed between the antenna 110 and the circuit board structure 180, thereby reducing the impact of the overall parasitic capacitance on the sensing ability of the touch chip 150 and improving touch accuracy.

It should be noted that the relative position relationship between the circuit board 181 and the antenna 110 is not limited to parallel placement as shown in FIG. 9, and may also be any other placement manner that may reduce the parasitic capacitance. For example, the circuit board 181 may be placed at a certain angle relative to the antenna 110, such as perpendicular to the antenna 110, in order to further reduce the parasitic capacitance generated between the circuit board 181 and the antenna 110, which is not limited in the present disclosure. In addition, the distance relationship between the circuit board 181, the circuit board 182, and the antenna 110 shown in FIG. 9 is for illustrative purposes only. In some embodiments, the distance d1 between the circuit board 181 and the antenna 110 may be smaller than the distance d2 between the circuit board 182 and the antenna 110. In other words, either circuit board 181 or circuit board 182 may be kept away from the antenna 110 relative to the other, thereby reducing the overall parasitic capacitance of the antenna and improving the accuracy of touch control.

The present disclosure uses two circuit boards to implement touch and RF functions respectively. The two circuit boards are connected through the connector, and the distance between either circuit board and the antenna is increased. This ensures the integrity of the circuit board structure in the antenna touch multiplexing device while reducing the overall parasitic capacitance of the antenna and improving the accuracy of touch control.

FIG. 10 is a schematic diagram illustrating an antenna layout according to some embodiments of the present disclosure. As shown in FIG. 10, the antenna 110 is located inside and close to the housing 11. In some embodiments, the antenna 110 is positioned in a central region of the housing 11 and arranged in a zigzag shape. As a capacitor plate, the closer the antenna 110 is to the edge of the housing 11, the more likely it is for users to accidentally touch the edge of the housing 11. The antenna 110 is arranged in a zigzag shape in the central region of the housing 11 in the embodiments of the present disclosure. With the same antenna length, the antenna 110 may be further away from the edge of the housing 11, avoiding accidental touches caused by users touching the edge of the housing 11, thereby improving the touch control accuracy of the antenna 110. In addition, by arranging the antenna 110 in a zigzag shape, a longer antenna wiring may be formed within a small size range in the central region of the housing 10, thereby increasing the effective size of the antenna 110, enhancing the sensitivity of the antenna 110 to transmit and receive signals, thereby improving the stability and transmission speed of the signals.

Optionally or additionally, the effective size of the antenna 110 is equal to one fourth of the wavelength of the RF signal. The effective size of the antenna 110 refers to the equivalent length of the antenna assuming that the current distribution on the antenna is uniform, while keeping the field strength value in the actual maximum radiation direction unchanged. The zigzag shape arrangement of the embodiments in the present disclosure reduces the space of the antenna 110 on the basis that the effective size is equal to one fourth of the wavelength of the RF signal, thereby improving the stability and transmission speed of the signal without changing the resonant frequency of the antenna 110.

In some embodiments, when the antenna 110 is arranged in a zigzag shape, the antenna 110 may include one or more sets of adjacent parallel segments. For example, as shown in FIG. 10, the antenna 110 includes a parallel segment 113, a parallel segment 114, and a parallel segment 115 as indicated by dashed lines. The parallel segment 113 and the parallel segment 114 form one set of adjacent parallel segments, and the parallel segment 114 and the parallel segment 115 form another set of adjacent parallel segments. When the current flows from one end of the antenna to the other, due to the zigzag shape arrangement of the antenna 110, current directions in adjacent parallel segments are opposite, resulting in the cancellation of the RF signals radiated by adjacent parallel segments. In some embodiments, the lengths of adjacent parallel segments in each set of adjacent parallel segments of the antenna 110 are different. For example, as shown in FIG. 10, the length of the parallel segment 114 is greater than the length of the parallel segment 113. As another example, the length of the parallel segment 114 is greater than the length of the parallel segment 115. This setting allows the parallel segment 113 (or the parallel segment 115) to only cancel radiation with the a portion of the parallel segment 114 (e.g., the portion of the parallel segment 114 corresponding to parallel segment 113 (or the parallel segment 115)), without affecting the RF signal radiated by another portion of the parallel segment 114 (e.g., the portion of parallel segment 114 longer than the parallel segment 113 (or the parallel segment 115)), thereby reducing the degree of radiation cancellation caused by reverse current on two adjacent parallel segments and ensuring the radiation efficiency of the antenna 110.

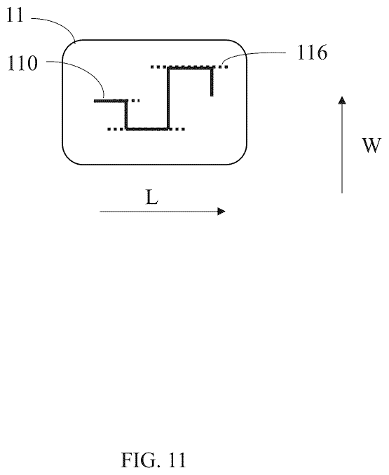

FIG. 11 is a schematic diagram illustrating an antenna layout according to some embodiments of the present disclosure. As shown in FIG. 11, the antenna 110 is arranged in the central region of the housing 11 and arranged in a zigzag shape, with a corner of the zigzag shape including one or more extended branches. The corner of the zigzag shape may be formed by two consecutive line segments with different directions. For example, as shown in FIG. 11, the zigzag shape of the antenna 110 may include a plurality of corners, and each corner is formed by a line segment along a length direction L of the housing 11 and a line segment along a width direction W. The extension direction of the branch may be the same as the direction of a line segment. For example, as shown by the dashed line in FIG. 11, the branch 116 may extend along the length direction L of the housing 11 at the corner. Due to the relatively large size of the housing 11 in the length direction, when the branch is set to extend along the length direction L of the housing 11, even if the overall size of the antenna 110 including the branch increases in the length direction, the whole antenna 110 may still be far away from the edge of the housing 11, thereby avoiding accidental touches caused by users touching the edge of the housing 11. It should be noted that the extension direction of the branch shown in FIG. 11 is only for illustrative purposes. In some embodiments, the branch may also extend in other directions while avoiding accidental contact, which is not limited in the present disclosure. For example, the branch may extend along the width direction W of the housing 11. For example, a corner may include a plurality of branches extending in different directions (e.g., the length direction L and the width direction W).

The extension length of the branch may be relatively short (for example, shorter than the effective length of the antenna 110), so it may not change the effective length of the antenna 110, and thus may not change the resonant frequency of the antenna 110. In addition, the branch may be allocated with current flowing through the antenna 110, thereby increasing the effective radiation aperture of the antenna 110 and improving the performance of the antenna 110.

In summary, the touch chip 150 is connected to the antenna 110 via the touch signal transmission path 120. The RF chip 160 is connected to the antenna 110 via the RF transmission path. The antenna 110 may transmit the RF signal, and may also play the role of a touch electrode. In this way, the function of the antenna 110 and the touch control function are integrated into one, which makes the antenna touch multiplexing device 100 compact, and thus reduces the technical problem of conflicting layout spaces in electronic devices 1 such as the headphone 10 and other electronic devices 1 of the present disclosure may be reduced. In the embodiment of the antenna touch multiplexing device 100 of the present disclosure, the touch signal transmission path 120 includes a first low pass filtering module 121 and a second low pass filtering module connected in series. The wiring distance between the first low pass filtering module 121 and the antenna 110 is less than the wiring distance between the first low pass filtering module 121 and the second low pass filtering module 122. The wiring distance between the second low pass filtering module 122 and the touch chip 150 is less than the wiring distance between the first low pass filtering module 121 and the second low pass filtering module 122. In other words, the first low pass filtering module 121 is disposed proximate to the antenna 110, and the second low pass filtering module 122 is disposed proximate to the touch chip 150. In this way, the first low pass filtering module 121 may block the RF signal in the antenna touch multiplexing device 100 and reduce its interference with the touch chip 150. The second low pass filtering module 122 may further block the RF signal, further reducing the interference of the RF signal on the touch signal. As the first low pass filtering module 121 is set close to the antenna 110, the second low pass filtering module 122 is set close to the touch chip 150. The RF signal radiated from and received by the antenna 110 is less likely to be coupled with the wire between the first low pass filtering module 121 and the antenna 110 and the wire between the second low pass filtering module 122 and the touch chip 150 to generate an interference signal, ensuring the reliability of the touch control performance. Moreover, signals generated by the coupling of the wire between the first low pass filtering module 121 and the second low pass filtering module 122 with the RF signals are blocked by the first low pass filtering module 121 and the second low pass filtering module 122 from two ends of the wire, respectively. The coupling of the wire between the first low pass filtering module 121 and the second low pass filtering module 122 with the RF signal may not affect the touch chip 150 and the RF chip 160. Thus, the relative position of the antenna 110 and the touch chip 150 may be flexibly arranged to optimize the spatial layout of the antenna touch multiplexing device 100.

Furthermore, in the present disclosure, unless otherwise expressly provided and limited, the terms “connected”, “connection (electrically connection)”, “stacked”, or the like are to be broadly construed. For example, as a fixed connection, a detachable connection, or a one-piece connection; a direct connection or an indirect connection through an intermediate medium or an interaction between two elements. To a person of ordinary skill in the art, the specific meaning of the above terms in the present disclosure may be understood on a case-by-case basis.

Finally, it should be noted that the above embodiments are only used to illustrate the technical solutions of the present disclosure, and are not intended to be a limitation thereof. Notwithstanding that the present disclosure has been described in detail with reference to the foregoing embodiments, it should be understood by a person of ordinary skill in the art may modify or replace some or all of the technical solutions recorded in the foregoing embodiments with equivalent technical features. Such modification or replacement does not take the essence of the corresponding technical solutions out of the scope of the technical solutions of the various embodiments of the present disclosure.

What is claimed is:

1. An antenna touch multiplexing device, comprising:
an antenna;
a touch signal transmission path, connected to the antenna and configured to transmit a touch signal;
a radiofrequency (RF) signal transmission path, connected to the antenna and configured to transmit an RF signal;
a touch chip connected to the antenna via the touch signal transmission path; and
an RF chip connected to the antenna via the RF signal transmission path, wherein
the touch signal transmission path includes a first low pass filtering module and a second low pass filtering module connected in series between the antenna and the touch chip, wherein
a wiring distance between the first low pass filtering module and the antenna is less than a wiring distance between the first low pass filtering module and the second low pass filtering module; and
a wiring distance between the second low pass filtering module and the touch chip is less than a wiring distance between the first low pass filtering module and the second low pass filtering module.

2. The antenna touch multiplexing device of claim 1, wherein
the wiring distance between the first low pass filtering module and the antenna is within a range of 0.2-90 mm.

3. The antenna touch multiplexing device of claim 1, wherein
the wiring distance between the second low pass filtering module and the touch chip is within a range of 0.2-90 mm.

4. The antenna touch multiplexing device of claim 1, wherein:
the RF signal transmission path includes a first high pass filtering module connected in series between the antenna and the RF chip.

5. The antenna touch multiplexing device of claim 4, wherein
the first high pass filtering module is a capacitive circuit and has a capacitance value less than or equal to 1 μF.

6. The antenna touch multiplexing device of claim 4, further comprising a third low pass filtering module, wherein
one end of the third low pass filtering module is connected to a node between the first high pass filtering module and the RF chip, and the other end of the third low pass filtering module is grounded.

7. The antenna touch multiplexing device of claim 6, wherein
the first high pass filtering module includes a capacitor, and the third low pass filtering module includes an inductor, and the inductor is disposed on a side of the capacitor away from the antenna.

8. The antenna touch multiplexing device of claim 6, further comprising an antenna matching module, wherein
the antenna matching module is provided between the first high pass filtering module and the RF chip, an end of the antenna matching module is connected to the first high pass filtering module and an another end of the antenna matching module is connected to the RF chip, and an end of the third low pass filtering module is connected to a node between the first high pass filtering module and the antenna matching module.

9. The antenna touch multiplexing device of claim 1, wherein
the first low pass filtering module is an inductive circuit with an inductance value greater than or equal to 22 nH, and/or the second low pass filtering module is an inductive circuit with an inductance value greater than or equal to 22 nH.

10. The antenna touch multiplexing device of claim 1, wherein
the antenna has an antenna feed point, and the touch signal transmission path and the RF signal transmission path are electrically connected with the antenna feed point.

11. The antenna touch multiplexing device of claim 1, wherein
the antenna has an antenna feed point and an antenna location, the RF signal transmission path is electrically connected with the antenna feed point, and the touch signal transmission path is electrically connected with the antenna location; and
the antenna touch multiplexing device further comprises a grounding path, the grounding path includes a second high pass filtering module, an end of the second high pass filtering module is electrically connected with the antenna location, and another end of the second high pass filtering module is grounded.

12. The antenna touch multiplexing device of claim 12, wherein:
the second high pass filtering module further forms an inductor-capacitor (LC) resonant circuit within the grounding path, and a resonant frequency of the LC resonant circuit is less than an operating frequency of the RF signal.

13. The antenna touch multiplexing device of claim 12, wherein
the second high pass filtering module is a capacitive circuit with a capacitance value less than or equal to 1 μF.

14. The antenna touch multiplexing device of claim 14, wherein
the second high pass filtering module is provided to cooperate with wiring within the grounding path to form the LC resonant circuit.

15. The antenna touch multiplexing device of claim 14, wherein
the capacitance value of the second high pass filtering module is greater than or equal to 22 pF.

16. The antenna touch multiplexing device of claim 1, wherein
the touch chip is communicatively connected with the RF chip.

17. The antenna touch multiplexing device of claim 1, further comprising a first circuit board, a second circuit board, and a connector, wherein
the RF signal transmission path and the RF chip is implemented on the first circuit board,
the touch signal transmission path and the touch chip are implemented on the second circuit board, and
the first circuit board is connected with the second circuit board through the connector.

18. The antenna touch multiplexing device of claim 17, wherein the first circuit board and the second circuit board are placed at intervals from the antenna, and a distance from one of the first circuit board and the second circuit board to the antenna is greater than a distance from another one of the first circuit board and the second circuit board to the antenna.

19. The antenna touch multiplexing device of claim 1, wherein the antenna is arranged in a zigzag shape and includes one or more sets of adjacent parallel segments, and lengths of two adjacent parallel segments in each of the one or more sets of adjacent parallel segments are different.

20. The antenna touch multiplexing device of claim 1, wherein the antenna is arranged in a zigzag shape, and a corner of the zigzag shape includes one or more branches.
